(19) United States
(12) Patent Application Publication
(10) Pub. No.: US 2026/0054539 A1
(43) Pub. Date: Feb. 26, 2026

(54) VEHICLE HAVING ELECTRIC AIR CONDITIONING COMPRESSOR PROTECTION ASSEMBLY

(71) Applicant: FCA US LLC, Auburn Hills, MI (US)

(72) Inventors: Vikas Sanghavi, Auburn Hills, MI (US); Milind Parab, Auburn Hills, MI (US); Ranjit Pandhare, Auburn Hills, MI (US); Meyyappan Valliappan, Auburn Hills, MI (US)

(21) Appl. No.: 18/810,620

(22) Filed: Aug. 21, 2024

(51) Int. Cl. B60H 1/00; B60R 16/02

(52) U.S. Cl. CPC B60H 1/00514; B60R 16/0215

(57) ABSTRACT

A vehicle including a propulsion system; a high-voltage electric air conditioning (EAC) unit attached to the propulsion system; a heating, ventilation, and air conditioning (HVAC) module positioned proximate the EAC unit; and a protection assembly fixed to the EAC unit in a manner where the high-voltage component is at least partially sandwiched between the protection assembly and the propulsion system, wherein the protection assembly is configured to protect the EAC unit from being contacted by the HVAC module during a collision event.

### FIELD

The present disclosure relates to a vehicle having an electric air conditioning compressor protection assembly.

### BACKGROUND

This section provides background information related to the present disclosure which is not necessarily prior art.

Vehicles are currently being manufactured that may include an internal combustion engine (ICE) drivetrain, a battery-powered drivetrain, or a combination of an ICE drivetrain and battery-powered drivetrain (i.e., hybrid). Because hybrid vehicles include a combination of an ICE drivetrain and a battery-powered drivetrain, hybrid vehicles can be much heavier in comparison to vehicles that include only an ICE drivetrain or a battery-powered drivetrain. This additional mass can lead to components of the hybrid vehicle being exposed to greater forces during a collision event.

Specifically, when some types of hybrid vehicles are subjected to high-speed driver side small overlap (DSORB) impact testing, there may be instances where the forces generated during such an impact are sufficient to cause the structure integrity of a housing of a high-voltage component of the hybrid vehicle to fail. If the housing of the high-voltage component fails, there is a potential for sharp edges to be formed that can damage the sensitive features of the high-voltage component located in the housing, which is undesirable.

Moreover, regardless whether the vehicle contains a hybrid drivetrain, an ICE drivetrain, or an electrically-powered drivetrain, the fact remains that vehicles are increasingly incorporating a larger number of high-voltage components that require protection from damage during a collision event.

### SUMMARY

This section provides a general summary of the disclosure, and is not a comprehensive disclosure of its full scope or all of its features.

According to an aspect of the present disclosure, there is provided a vehicle that includes a propulsion system; a high-voltage electric air conditioning (EAC) unit attached to the propulsion system; a heating, ventilation, and air conditioning (HVAC) module positioned proximate the EAC unit; and a protection assembly fixed to the EAC unit in a manner where the high-voltage component is at least partially sandwiched between the protection assembly and the propulsion system, wherein the protection assembly is configured to protect the EAC unit from being contacted by the HVAC module during a collision event.

According to the aspect, the vehicle may also include a steering column that is positioned proximate and extending adjacent along at least a portion of a length of the EAC unit, wherein the protection assembly is configured to protect the EAC unit from being contacted by the steering column during a collision event.

According to the aspect, the protection assembly includes a first protective shield, a second protective shield, a third protective shield, and a fourth protective shield.

According to the aspect, the EAC unit includes a forward end that faces the HVAC module, a first side that faces away from the propulsion system, a second side that faces the propulsion system, and an aft side that faces away from the HVAC module.

According to the aspect, the first protective shield and the second protective shield collectively provide protection for the forward end of the EAC unit, the second protective shield, the third, protective shield, and the fourth protective shield collectively provide protection for the first side of the EAC unit, and the fourth protective shield provides protection for the aft end of the EAC unit.

According to the aspect, the EAC unit includes a high-voltage cable attached thereto, and the third protective shield provides protection for the high-voltage cable during the collision event.

According to the aspect, the third protective shield includes an aperture configured for receipt of a bracket clip that is configured to support, orient, and direct the high-voltage cable relative to the EAC unit and the third protective shield.

According to the aspect, the first and second protective shields overlap each other, the second and fourth protective shields overlap each other, and the third and fourth protective shields overlap each other.

According to the aspect, each of the first to fourth protective shields are spaced apart from the EAC unit by a gap such that during the collision event, the protection assembly is configured to deform without contacting the EAC unit.

According to the aspect, each of at least the first, second, and fourth protective shields includes a flange or tab extending outward from a body of the respective first, second, and fourth protective shield that is configured to provide the gap.

According to the aspect, the first protective shield includes a first plate-shaped body that provides protection to the forward end of the EAC unit, and has a first elongated flange extending outward from the first plate-shaped body that overlaps the second protective shield.

According to the aspect, the second protective shield includes a second body that includes a first section that provides protection to the forward end of the EAC unit and is overlapped by the first elongated flange of the first protective shield, and a second section that provides protection to the first side of the EAC unit.

According to the aspect, the third protective shield is attached to the fourth protective shield, and includes a third plate-shaped body that provides protection to the first side of the EAC unit.

According to the aspect, the third protective shield includes a plurality of strengthening ribs.

According to the aspect, the fourth protective shield includes a fourth body that includes a third section that provides protection to the first side of the EAC unit and a fourth section that provides protection to the aft end of the EAC unit, the third section including a second elongated flange that overlaps the second section of the second protective shield.

According to the aspect, each of the first to fourth protective shields of the protection assembly are formed of a rigid metal material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial overhead perspective view of a vehicle frame of a vehicle according to a principle of the present disclosure;

FIG. 2 is a partial overhead perspective of FIG. 1, after the vehicle has experienced a collision event;

FIG. 3 is a perspective view of a high-voltage electric air conditioning (EAC) unit that may result after being contacted by various vehicle components during the collision event illustrated in FIG. 2;

FIG. 4 is a side perspective view of an example EAC unit having a protection assembly according to a principle of the present disclosure attached thereto;

FIG. 5 is another side perspective view of the example EAC unit illustrated in FIG. 4 having the protection assembly according to a principle of the present disclosure attached thereto;

FIG. 6 is another side perspective view of the example EAC unit illustrated in FIG. 4 having the protection assembly according to a principle of the present disclosure attached thereto;

FIG. 7 is a forward perspective view of the example EAC unit illustrated in FIG. 4 having the protection assembly according to a principle of the present disclosure attached thereto;

FIG. 8 is an aft perspective view of the example EAC unit illustrated in FIG. 4 having the protection assembly according to a principle of the present disclosure attached thereto;

FIGS. 9 and 10 are perspective views of a first protective shield that is part of the protection assembly;

FIGS. 11 and 12 are perspective views of a second protective shield that is part of the protection assembly;

FIGS. 13 and 14 are perspective views of a fourth protective shield that is part of the protection assembly; and

FIGS. 15 and 16 are perspective views of a third protective shield that is part of the protection assembly.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

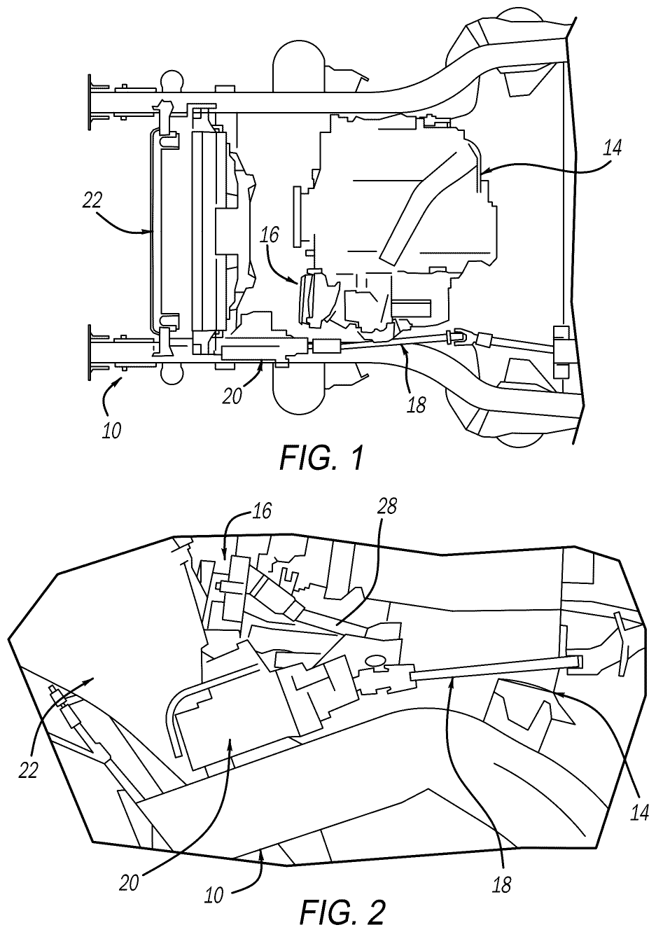

FIG. 1 illustrates a partial view of a frame 10 of a vehicle 12 that includes an internal combustion engine 14 (ICE) having an electric air conditioning unit 16 (EAC) attached thereto. While only ICE 14 is illustrated, it should be understood that vehicle 12 may additionally include components such as a battery pack (not shown) and electric drive modules (not shown) for electrically powering wheels (not shown) of vehicle 12 such that vehicle 12 may be a hybrid-powered vehicle. Additional features of vehicle 12 illustrated in FIG. 1 include a steering column 18 connected to a power steering assembly 20 and a forward HVAC module 22 in communication with the EAC 16 that may include, for example, a condenser (not shown) and fan (not shown) that are part of a vehicle HVAC system, as well as a radiator (not shown) that may circulate a coolant for ICE 14.

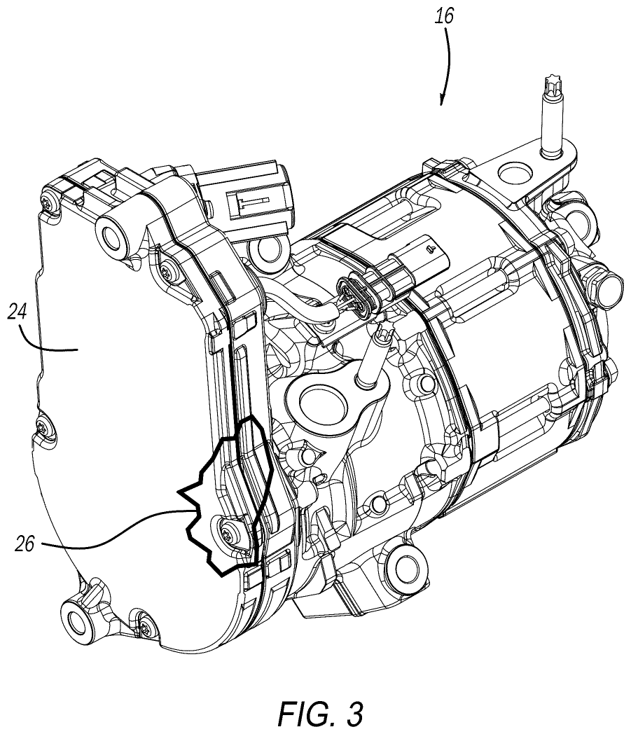

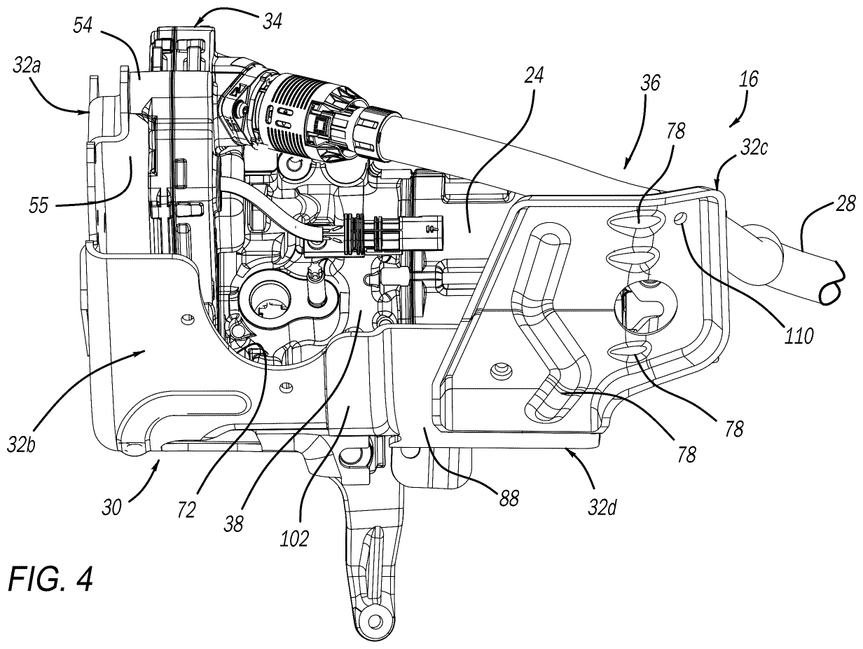

Now referring to FIGS. 2 and 3 with continued reference to FIG. 1, it can be seen that when vehicle 12 is involved in a front-end collision with an object or another vehicle the forward HVAC module 22, steering column 18, and power steering assembly 20 can be forced in a direction back toward ICE 14 and EAC unit 16. If the forces experienced during the collision event are of sufficient magnitude, contact may occur between these components and the EAC unit 16 that can potentially damage the EAC unit 16. Indeed, as best shown in FIG. 3, forceful contact between the EAC unit 16 and any of the HVAC module 22, steering column 18, and power steering assembly 20 can cause a housing or shell 24 of EAC unit 16 to crack or break. If housing or shell 24 breaks, sharp edges 26 can form that could potentially sever a high voltage cable 28 that provides power to EAC unit 16. Alternatively, if cable 28 is not damaged or severed, high-voltage components (not shown) located within housing 24 could be exposed. In either case, it is desirable to avoid damage to EAC unit 16 and cable 28.

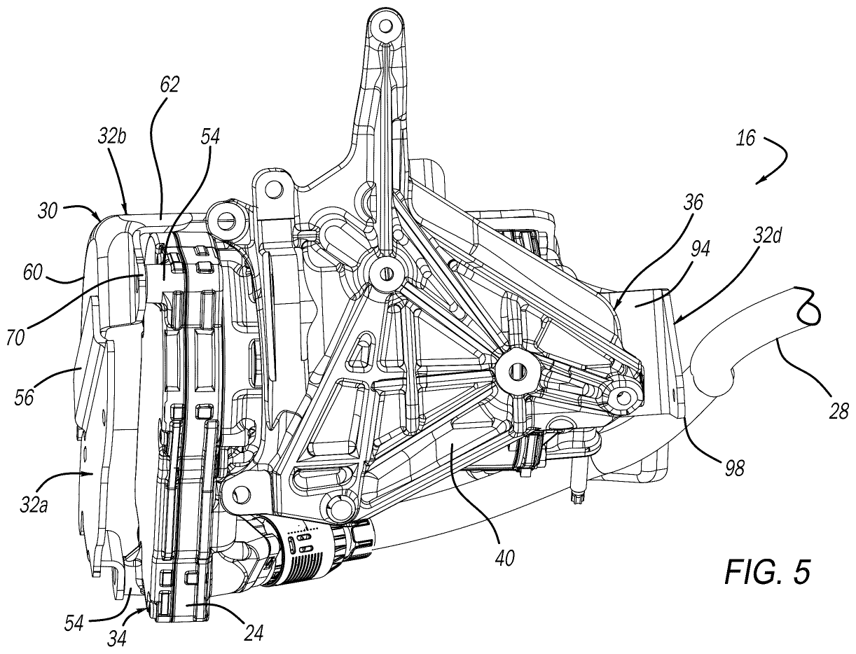

In view of the above, it is desirable to protect EAC unit 16 and cable 28. To this end, the present disclosure provides a protection assembly 30 that is attached to EAC unit 16, and is designed and configured to protect EAC unit 16 and cable 28 from being damaged during a collision event. ECU unit 16 having protection assembly 30 attached thereto is shown in FIGS. 4-8. As shown in FIGS. 4-8, protection assembly 30 may include a plurality of protective shields 32a, 32b, 32c, and 32d that collectively mate together to form protection assembly 30.

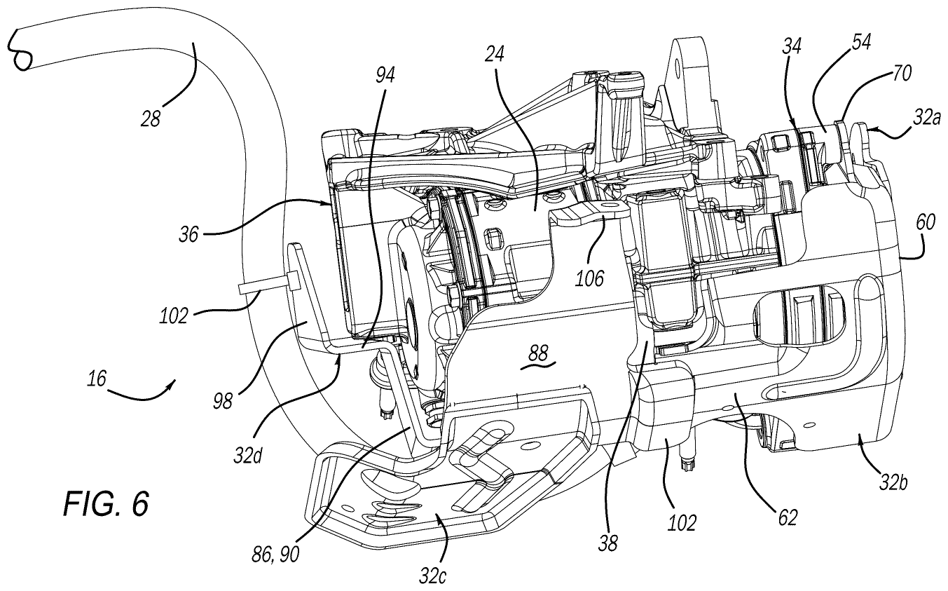

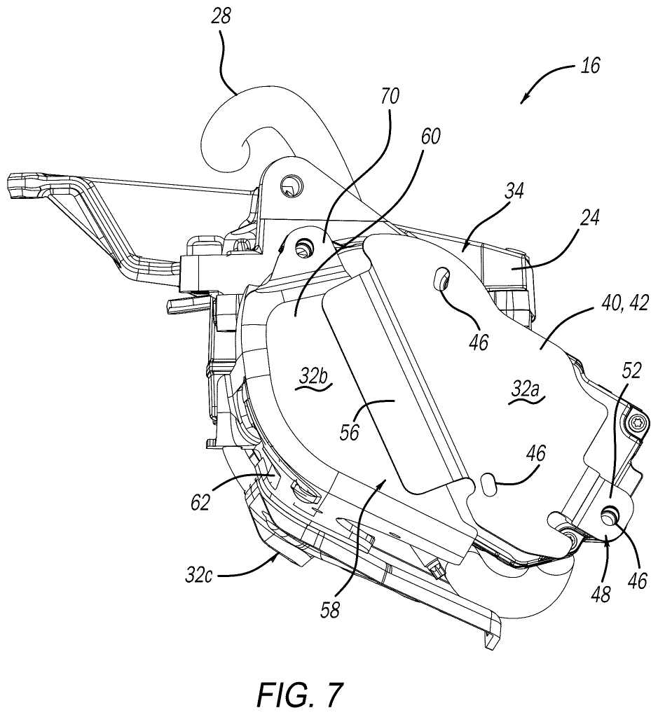

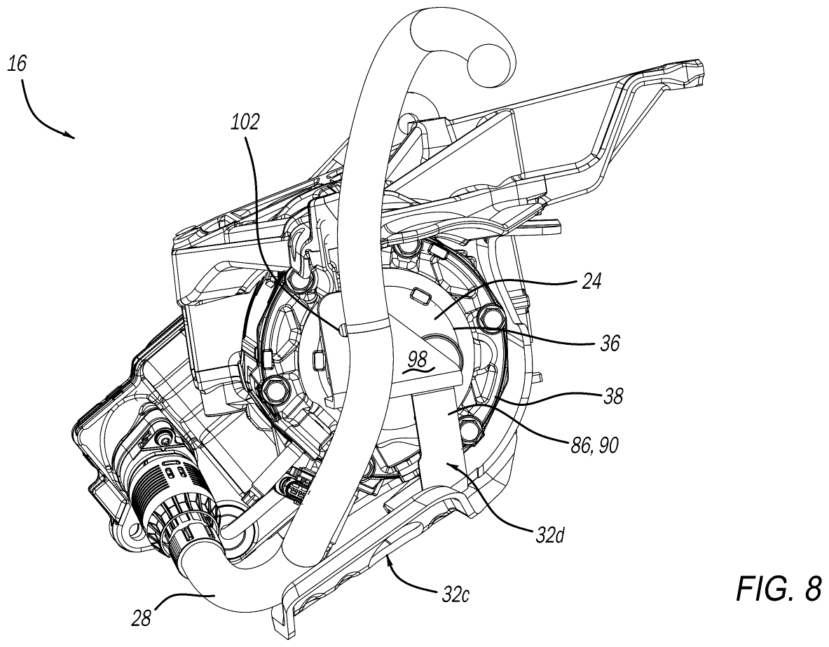

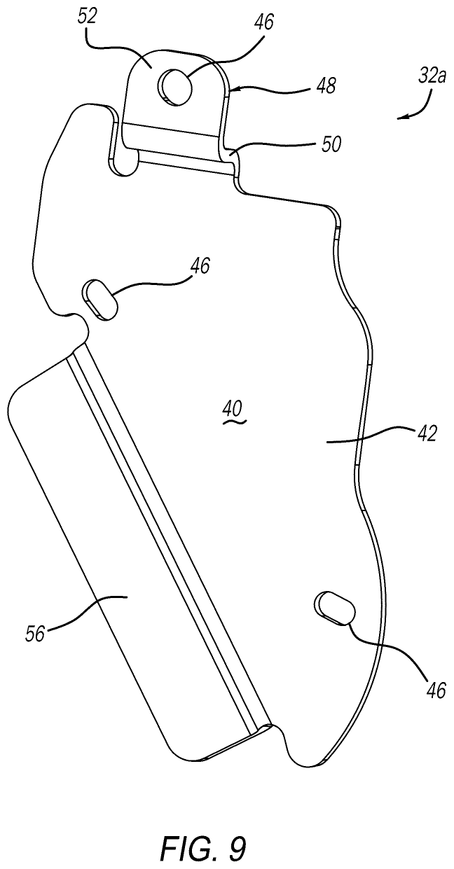

FIG. 4 illustrates a side perspective view of EAC unit 16 having protection assembly 30 attached thereto. Put another way, FIG. 4 illustrates a side of the EAC unit 16 that may be contacted by at least one of steering column 18 and power steering assembly 20 during a collision event. In the illustrated embodiment, EAC unit 16 has a forward end 34 that faces forward HVAC module 22, an aft end 36 that faces away from forward HVAC module 22, a first side 38 that faces steering column 18, and an opposite second side 40 that faces and is attached to ICE 14. FIG. 5 illustrates the opposite second side 40 of EAC unit 16, which is a side of the EAC unit 16 that is fixed to ICE 14 and does not require protection. FIG. 6 is another side perspective view of the EAC unit 16 that is similar to FIG. 4 (i.e., shows first side 38), but shows aft end 36 in more detail. FIG. 7 is a front perspective view of EAC unit 16 (i.e., shows forward end 34), and FIG. 8 is a rear perspective view of EAC unit 16 (i.e., shows aft end 36).

As noted above, protection assembly 30 includes protective shields 32a, 32b, 32c, and 32d. As best shown in FIGS. 5 and 7, protective shields 32a and 32b are attached to EAC unit 16 in a manner to collectively provide protection to forward end 34. As best shown in FIGS. 4, 6, and 8, protective shields 32b, 32c, and 32d collectively provide protection for first side 38 and aft end 36.

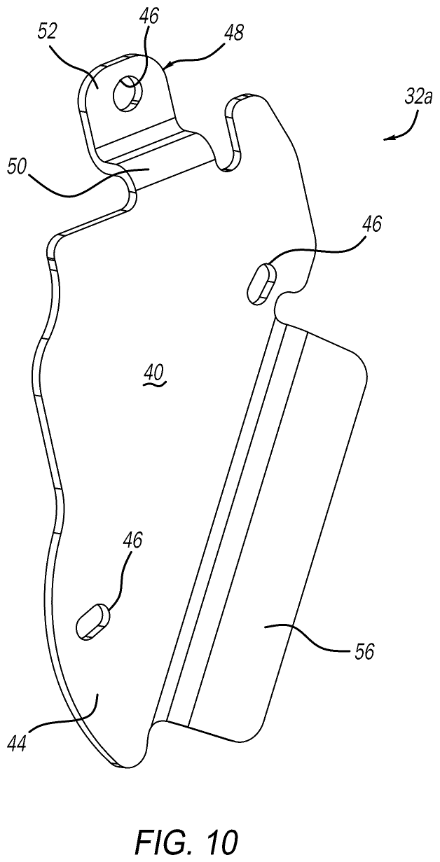

With reference to FIGS. 4, 7, 9, and 10, protective shield 32a includes a first plate-shaped body 40 having an inner surface 42 (FIG. 9) that faces forward end 34 of EAC unit 16 and an outer surface 44 (FIGS. 5, 7, and 10) that faces away from forward end 34 of EAC unit 16. First plate-shaped body 40 may include a plurality of apertures 46 that are configured to align with various threaded bores (not shown) formed in forward end 34 of EAC unit 16, and configured to receive a fastener (not shown) that can rigidly attach protective shield 32a to forward end 34 of EAC unit 16. In addition, to provide a gap between protective shield 32a and EAC unit 16, first plate-shaped body 40 includes an L-shaped flange 48 having a first arm 50 that extends outward from first plate-shaped body 40 in a direction toward EAC unit 16 and a second arm 52 that extends outward in a substantially orthogonal direction relative to first arm 50 that also includes an aperture 46 configured for receipt of a fastener (not shown) that aligns with a threaded bore 54 provided at forward end 34 of EAC unit 16. L-shaped flange 48 is designed to maintain a gap 55 (FIG. 4) between first plate-shaped body 40 and forward end 34 of EAC unit 16 such that in the event that protective shield 32a is contacted by a vehicle component during a collision event, protective shield 32a may deform without contacting EAC unit 16. An elongated flange 56 also extends outward from first plate-shaped body 40 that is configured to overlap and abut protective shield 32b. While not illustrated in the drawings, it should be understood that a sealant or some other type of vibration-deadening material may be provided between elongated flange 56 and protective shield 32b to dampen vibrations experienced by protection assembly 30 during operation of vehicle 12.

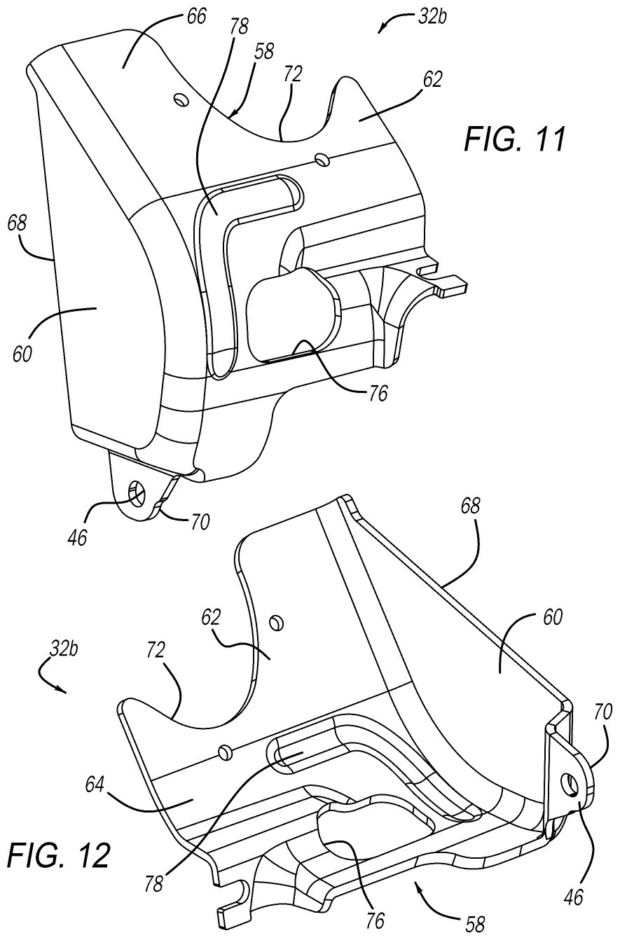

Now referring to FIGS. 11 and 12, and with continued reference to FIGS. 4-7, protective shield 32b includes a second body 58 that includes a first section 60 that is configured to face forward end 34 of EAC unit 16, and a second section 62 that is configured to face first side 38 of EAC unit 16. Second body 58 includes an interior surface 64 that faces EAC unit 16 and an exterior surface 66 that faces away from EAC unit 16. First section 60 includes an edge 68 that is configured to abut against elongated flange 56, and also includes an outwardly extending tab 70 having an aperture 46 configured for receipt of a fastener (not shown) and configured to align with another threaded bore 54 (FIG. 5) provided at forward end 34 of EAC unit 16. Similar to L-shaped flange 48, tab 70 extends outward from first section 60 in a manner such that when tab 70 is attached to EAC unit 16 at threaded bore 54, the gap 55 will be maintained between protective shield 32b and EAC unit 16.

Second section 62, as noted above, is designed to extend along a length of first side 38 of EAC unit 16. Second section 62 may be shaped to include various exterior contours 72 and openings 76 that can provide access to various exterior features 74 of EAC unit 16. In addition, second section 62 can be provided with various strengthening ribs 78 to increase the rigidity of protective shield 32b. In addition to tab 70, second section may include another tab 80 that defines a slot 82 configured to receipt of a fastener (not shown) that will mate with another threaded bore 54 provided at first side 38 of EAC unit 16.

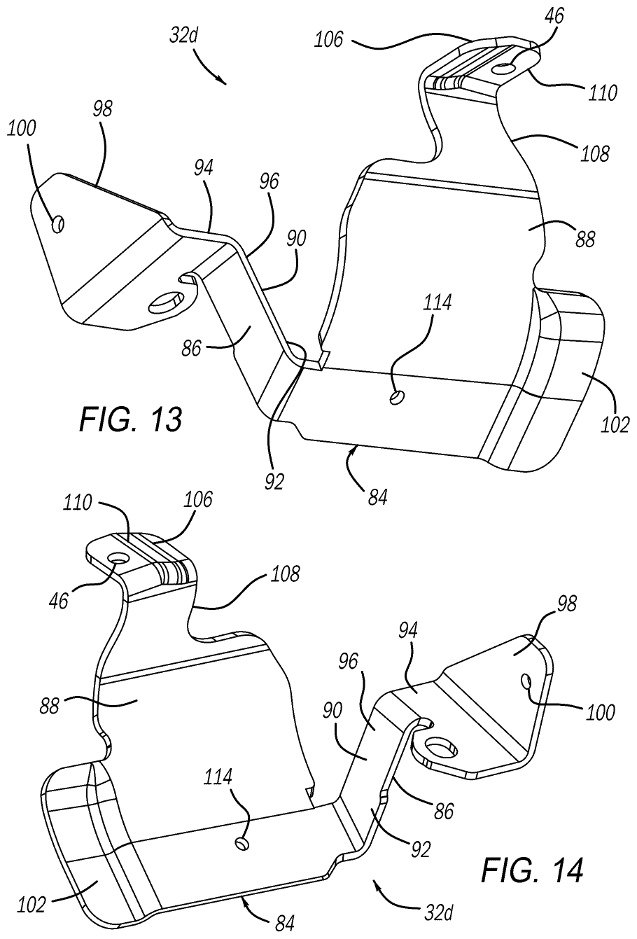

Now referring to FIGS. 13 and 14, and with continued reference to FIGS. 4-6 and 8, protective shield 32d will be described. Protective shield 32d, in some respects, is substantially similar to protective shield 32b. In this regard, protective shield 32d includes a third body 84 having a third section 86 that is configured to face aft end 36, and a fourth section 88 that is configured to face first side 38 of EAC unit 16. Third section 86 includes an upwardly extending first panel 90 having a proximate end 92 connected to second section 88. First section 86 is configured to overlap aft end 36. An outwardly extending second panel 94 extends substantially orthogonally outward from a distal end 96 of first panel 90, and a third panel 98 extends substantially orthogonally outward from second panel 94. As best shown in FIGS. 6 and 8, an aperture 100 provided in third panel 98 may be configured for receipt of a connection backet 102 that can connect and orient cable 28 relative to protection assembly 30 and EAC unit 16.

Fourth section 88, as noted above, is designed to extend along a length of first side 38 of EAC unit 16, and includes a mating flange 102 that is configured to overlap and abut against an edge 104 of protective shield 32b. Fourth section 88 also includes an outwardly extending second L-shaped flange 106 including a third arm 108 and a fourth arm 110 that extends substantially orthogonally outward from third arm 108. Fourth arm 110 may include an aperture 46 that is configured for receipt of a fastener (not shown) that can connect protective shield 32d to EAC unit 16.

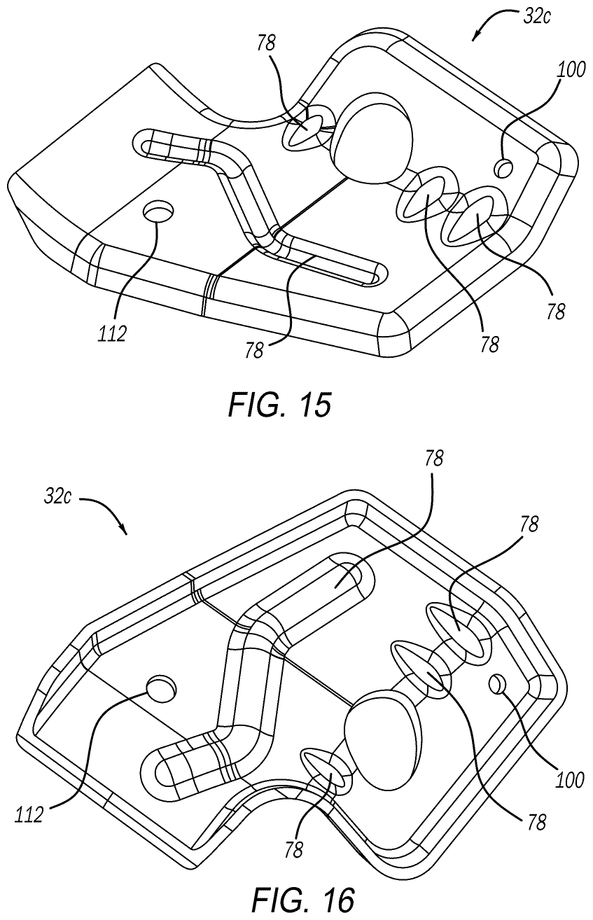

Now referring to FIGS. 15 and 16, protective shield 32c will be described. Protective shield 32c is configured to be attached to protective shield 32d using a fastener (not shown) that passes through a first through-hole 112 that aligns with a second through-hole 114 formed in protective shield 32d. Protective shield 32c is a generally plate-shaped member that, when attached to protective shield 32d, can provide additional protection to EAC unit 16, as well as provide protection for cable 28. In this regard, protective shield 32c includes an aperture 100 that is configured for receipt of another connection bracket 102 that can connect and orient cable 28 to relative to protection assembly 30 and EAC unit 16. Protective shield 32c can include a plurality of strengthening ribs 78 that can increase the rigidity of protective shield 32c.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a propulsion system;
a high-voltage electric air conditioning (EAC) unit attached to the propulsion system;
a heating, ventilation, and air conditioning (HVAC) module positioned proximate the EAC unit; and
a protection assembly fixed to the EAC unit in a manner where the high-voltage component is at least partially sandwiched between the protection assembly and the propulsion system;
wherein the protection assembly is configured to protect the EAC unit from being contacted by the HVAC module during a collision event.

2. The vehicle according to claim 1, further comprising a steering column that is positioned proximate and extending adjacent along at least a portion of a length of the EAC unit, wherein the protection assembly is configured to protect the EAC unit from being contacted by the steering column during a collision event.

3. The vehicle according to claim 1, wherein the protection assembly includes a first protective shield, a second protective shield, a third protective shield, and a fourth protective shield.

4. The vehicle according to claim 3, wherein the EAC unit includes a forward end that faces the HVAC module, a first side that faces away from the propulsion system, a second side that faces the propulsion system, and an aft side that faces away from the HVAC module.

5. The vehicle according to claim 4, wherein the first protective shield and the second protective shield collectively provide protection for the forward end of the EAC unit, the second protective shield, the third protective shield, and the fourth protective shield collectively provide protection for the first side of the EAC unit, and the fourth protective shield provides protection for the aft end of the EAC unit.

6. The vehicle according to claim 5, wherein the EAC unit includes a high-voltage cable attached thereto, and the third and fourth protective shields provide protection for the high-voltage cable during the collision event.

7. The vehicle according to claim 6, wherein the third protective shield includes an aperture configured for receipt of a bracket clip that is configured to support, orient, and direct the high-voltage cable relative to the EAC unit and the third protective shield.

8. The vehicle according to claim 5, wherein the first and second protective shields overlap each other, the second and fourth protective shields overlap each other, and the third and fourth protective shields overlap each other.

9. The vehicle according to claim 3, wherein each of the first to fourth protective shields are spaced apart from the EAC unit by a gap such that during the collision event, the protection assembly is configured to deform without contacting the EAC unit.

10. The vehicle according to claim 7, wherein each of at least the first, second, and fourth protective shields includes a flange or tab extending outward from a body of the respective first, second, and fourth protective shield that is configured to provide the gap.

11. The vehicle according to claim 4, wherein the first protective shield includes a first plate-shaped body that provides protection to the forward end of the EAC unit, and has a first elongated flange extending outward from the first plate-shaped body that overlaps the second protective shield.

12. The vehicle according to claim 9, wherein the second protective shield includes a second body that includes a first section that provides protection to the forward end of the EAC unit and is overlapped by the first elongated flange of the first protective shield, and a second section that provides protection to the first side of the EAC unit.

13. The vehicle according to claim 10, wherein the third protective shield is attached to the fourth protective shield, and includes a third plate-shaped body that provides protection to the first side of the EAC unit.

14. The vehicle according to claim 11, wherein the third protective shield includes a plurality of strengthening ribs.

15. The vehicle according to claim 11, wherein the fourth protective shield includes a fourth body that includes a third section that provides protection to the first side of the EAC unit and a fourth section that provides protection to the aft end of the EAC unit, the third section including a second elongated flange that overlaps the second section of the second protective shield.

16. The vehicle according to claim 3, wherein each of the first to fourth protective shields of the protection assembly are formed of a rigid metal material.
